(19) United States
(12) Patent Application Publication
(10) Pub. No.: US 2018/0243981 A1
(43) Pub. Date: Aug. 30, 2018

(54) PRINTED HOLLOW CHANNELS FORMED WITHIN AN OBJECT DURING FORMATION FOR INJECTION OF A BONDING MATERIAL

(71) Applicant: Additive Orthotics and Prosthetics LLC, Charlotte, NC (US)

(72) Inventors: Tyler MANEE, Frederick, MD (US); Tyler DUNHAM, Charlotte, NC (US)

(21) Appl. No.: 15/905,248

(22) Filed: Feb. 26, 2018

Related U.S. Application Data
(60) Provisional application No. 62/463,130, filed on Feb. 24, 2017.

(51) Int. Cl. B29C 64/188; B29C 64/118; B23K 26/342; B33Y 10/00; B33Y 30/00; B33Y 80/00

(52) U.S. Cl. CPC B29C 64/188; B29C 64/118; B23K 26/342; B29L 2031/7532; B33Y 30/00; B33Y 80/00; B33Y 10/00

(57) ABSTRACT

A method of manufacturing a prosthetic socket for use by a patient comprising dispensing a source material to form a layer of material, repeating the dispensing to form a plurality of stacked layers, forming in each one of a subset of the plurality of layers, when dispensing the material, one or more channels, wherein the channels formed in each of the subset of layers communicate with each other to form a complete channel having a selected length and shape, completing the dispensing of the source material to form the prosthetic socket, and filling the channels with a bonding material such that the bonding material strengthens the bond between adjacent ones of the subset of the plurality of layers having the channels formed therein.

### RELATED APPLICATIONS

This application claims priority to U.S. provisional patent application Ser. No. 62/463,130, filed on Feb. 24, 2017, entitled PRINTED HOLLOW CHANNELS WITHIN AN OBJECT FOR INJECTION OF A BONDING AGENT, the contents of which are herein incorporated by reference.

### BACKGROUND OF THE INVENTION

The present invention is related to forming objects or workpieces using additive manufacturing or printing techniques, and more specifically related to forming objects or workpieces using three dimensional (3D) printing techniques.

Conventional prosthetic sockets and orthopedic braces are typically custom produced for each patient to ensure that the contours of the devices closely match that of the person who is wearing the device. Additive manufacturing lends itself to production of custom, often single-unit devices. This technology is being used to produce conventional sockets and braces, which undergo high stresses during use by the patient. Due to the laminar nature of 3D-printed materials, delamination of the layers is a frequent cause of failure of these devices. This is caused by inadequate inter-layer adhesion.

Current methods to increase inter-layer adhesion include encasing the entire object in a fiber/resin shell, vapor smoothing of ridges on external surfaces, and painted-on resins. Encasing the object in a laminated shell moves stresses to the outside shell, thus reducing the load/stresses on the 3D printed inner structure. Vapor smoothing of edges helps address this issue by removing the crevice between layers and dispersing stress risers to distribute load. Resins painted on the outside surface of the object act as a ‘glue’ and provide additional adhesion between layers on external surfaces of the device.

### SUMMARY OF THE INVENTION

An object of the present invention is to produce, manufacture or form an object, such as a prosthetic socket or orthopedic brace, using 3D printing techniques, while concomitantly promoting adhesion of adjacent layers of the device to avoid unwanted delamination.

The present invention is hence directed to an object formed by a selected additive manufacturing technique having a series of discrete channels formed therein as part of the manufacturing process, and during manufacture, so as to subsequently accommodate a strengthening and/or bonding material.

The method of the present invention includes a manufacturing a prosthetic socket for use by a patient, comprising dispensing a source material to form a layer of material, repeating the dispensing to form a plurality of stacked layers, forming in each one of a subset of the plurality of layers, when dispensing the material, one or more channels. The channels formed in each of the subset of layers communicate with each other to form a complete channel having a selected length and shape. The method also includes the steps of completing the dispensing of the source material to form the prosthetic socket, and filling the channels with a bonding material such that the bonding material strengthens the bond between adjacent ones of the subset of the plurality of layers having the channels formed therein.

The method can also include providing a reinforcing element in one or more of the channels prior to filling the channels with the bonding material.

The material used to form the prosthetic device can include thermoplastic, plastic, resin, metal, plaster, sandstone, nylon, polypropylene, and polyactic acid (PLA). Further, the dispensing device can be a printing device that forms part of a three dimensional (3D) printing system.

The prosthetic socket of the present invention has a wall thickness as measured between an inner surface of the prosthetic socket and an outer surface of the prosthetic socket between about 4.0 mm and about 15.0 mm. The channels formed in the layers have a diameter between about 1.0 mm and about 6.0 mm.

The present invention also contemplates a system for manufacturing a prosthetic socket for use by a patient, comprising an additive manufacturing system including a material source for providing a material, a dispensing device in communication with the material source for dispensing the material, and a manufacturing software facility in communication with the dispensing device for providing manufacturing data for forming the prosthetic socket. The manufacturing data includes instructions for creating the prosthetic socket by dispensing the material in a plurality of layers, wherein each one of a subset of the plurality of layers, when dispensing the material, includes one or more channels. The channels formed in each of the subset of layers communicate with each other to form a complete channel having a selected length and shape. The system also includes means for filling the channels with a bonding material such that the bonding material strengthens the bond between adjacent ones of the subset of the plurality of layers having the channels formed therein.

A reinforcing element can be disposed in one or more of the channels prior to filling the channels with the bonding material. The prosthetic socket is formed from a material that includes thermoplastic, plastic, resin, metal, plaster, sandstone, nylon, polypropylene, and polyactic acid (PLA). The dispensing device is a printing device that forms part of a three dimensional (3D) printing system. The prosthetic socket has a wall thickness as measured between an inner surface of the prosthetic socket and an outer surface of the prosthetic socket between about 4.0 mm and about 15.0 mm. Further, the channels formed in the layers have a diameter between about 1.0 mm and about 6.0 mm.

### BRIEF DESCRIPTION OF THE DRAWINGS

These and other features and advantages of the present invention will be more fully understood by reference to the following detailed description in conjunction with the attached drawings in which like reference numerals refer to like elements throughout the different views. The drawings illustrate principals of the invention and, although not to scale, show relative dimensions.

FIG. 1 is a block diagram schematic view of the manufacturing system according to the teachings of the present invention.

FIG. 2 is a perspective view of a prosthetic socket manufactured according to the teachings of the present invention.

FIG. 3 is a partial cut away view of the prosthetic socket of FIG. 2 showing the channels formed within the main body of the socket during manufacture according to the teachings of the present invention.

FIG. 4 is a partial cut away view of the prosthetic socket of FIG. 2 showing the channels formed within the main body of the socket during manufacture and filled with a bonding agent according to the teachings of the present invention.

FIG. 5 is a partial cut away view of another embodiment of the prosthetic socket of FIG. 2 showing the channels formed within the main body of the socket during manufacture and seating a reinforcing element according to the teachings of the present invention.

FIG. 6 is a partial cut away view of another embodiment of the prosthetic socket of FIG. 2 showing the channels formed within the main body of the socket during manufacture and seating a reinforcing element and filled with a bonding material according to the teachings of the present invention.

### DETAILED DESCRIPTION

The present invention is directed to an object or article formed by a selected additive manufacturing technique, such as a 3D printing technique, having a series of discrete openings, such as hollows or channels, formed therein as part of the printing process and during manufacture so as to subsequently accommodate a strengthening or bonding material.

The present invention is thus directed to a design which allows the bonding material to be injected into the openings formed within the three dimensional (3D) printed object during manufacture. The channels for example can be formed in the walls of the body of the object during manufacture. The openings or channels can be formed anywhere in the device and follow a path of any shape, size and at any selected location. The openings or channels can be distributed throughout the entire device, or can be focused in and around areas of high stress or expected or anticipated failure. The openings may be used in conjunction with geometric strengthening techniques (i.e., corrugation) or distributed through smooth areas of the device.

The benefits of this design approach include increasing inter-layer adhesion by acting as a bonding agent between adjacent layers, while concomitantly adding strength to the finished device via the rigidity of the injected bonding material. This inventive design allows inter-layer adhesion, as well as the overall strength, to be increased by applying adhesive/strength-augmenting materials within the walls or openings of the device. This is significantly different than applying adhesive/strength augmenting materials only to the outside of the device, as is currently practiced.

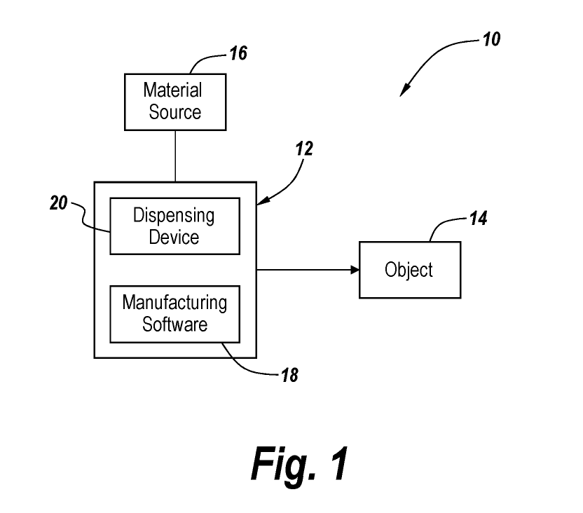

As shown in FIG. 1, the manufacturing system 10 of the present invention can include an additive manufacturing system or device 12 for forming an object 14. The illustrated additive manufacturing system 12 can include a material source 16 for supplying material to the additive manufacturing system 12. The additive manufacturing system can also include a manufacturing software facility or unit and associated hardware 18 for creating, manufacturing or forming the object. The manufacturing software facility 18 preferably generates and/or stores manufacturing data that assists with or directs the manufacturing system 10 to form the object The manufacturing data can include data from, for example, commercially available computer-aided design (CAD) software for designing the object, commercially available modeling software, and/or slicing software. Alternatively, the manufacturing data can be created and provided via a 3D scanner or by a plain digital camera and photogrammetry software.

The material source can be a separate component of the system or can be integrated with the additive manufacturing system 12. Further, the manufacturing software facility or unit 18 can for part of the additive manufacturing system 12, can be hosted on a separate computing device, or can be distributed throughout the system.

As is known, the additive manufacturing system 12 can also include a dispensing device 20 having a selected resolution. The dispensing device 20 can create or manufacture the object 14 in layers 56 that are vertically stacked on top of each other by dispensing (e.g., printing) the material to form the object. The material can be dispensed according to the manufacturing data and pattern provided by the manufacturing software 18. The dispensing device 20 also has a selected resolution that can be defined as either a layer thickness or height, or in dots per inch (dpi). According to the present invention, the layer of each thickness of the object can preferably be between about 0.1 mm and about 1.0 mm.

The additive manufacturing system 12 can be any selected system suitable for forming the object from a source material, and can be or include for example a printing system, and more specifically can be a three dimensional (3D) printing system. The additive manufacturing system 12 can implement manufacturing techniques that are configured to dispense, such as by melting or softening, the source material to produce the layers of the object during manufacture. For example, in fused filament fabrication, also known as fused deposition modeling (FDM), the object 14 is produced by extruding small beads or streams of material which harden immediately to form the layers of the object. Further, a filament of thermoplastic, metal wire, or other material is fed into the dispensing device 20, which can heat the material and turn the flow on and off. Another dispensing technique fuses parts of the layer and then moves upward in the working area, adding another layer of granules and repeating the process until the piece has built up. The additive manufacturing system 12 of the invention can also employ if desired a laser sintering technique that implements selective laser sintering, with both metals and polymers, and direct metal laser sintering. Selective laser melting does not necessarily use sintering for the fusion of powder granules but rather completely melts the powder using a high-energy laser to create fully dense materials in a layer-wise method that has mechanical properties similar to those of conventional manufactured metals. The additive manufacturing system 12 of the invention can also be configured to employ electron beam melting (EBM) for metal parts (e.g. titanium alloys). The implementation of EBM manufacturing techniques manufactures parts by melting metal powder layer by layer with an electron beam in a high vacuum environment. Yet another suitable, and preferable, implementation technique that can be employed by the additive manufacturing system 12 of the invention consists of an inkjet 3D printing system that employs a printing device as the dispensing device, which creates the model one layer at a time by spreading a layer of powder (plaster or resins) and printing a binder in the cross-section of the part using an inkjet-like process. As is known, the additive manufacturing system 12 can employ one or more electronic devices, which includes the necessary computing hardware, such as memory, processors and the like, for controlling the dispensing device 20. The manufacturing software facility can be resident within the additive manufacturing system 12 or can be located in a separate computing device or system that communicates with the additive manufacturing system 12 and can be if desired part of the manufacturing system 10.

The illustrated material source 16 can include any selected material suitable for dispensing by the dispensing device 20. For example, the material can be any suitable material including thermoplastic (such as for example acrylonitrile butadiene styrene (ABS)), plastic, resin, metal, plaster, sandstone, nylon, polypropylene, and polyactic acid (PLA). Other materials known to those of ordinary skill in the art can also be used. Some printable thermoplastic polymers such as ABS allow the surface finish to be smoothed and improved using known chemical vapor processes. The present invention also contemplates the use of multiple different material types either separately, simultaneously, in series, or as part of a mixture in the course of manufacturing the object. The material can be supplied to the additive manufacturing system 12 in any shape, type, form or composition, such as solid, liquid or powder or granulated form. The additive manufacturing system 12 can also dispense or print in multiple colors and color combinations either separately or simultaneously. As is known in the art, some printing techniques may require internal supports to be built for overhanging features during construction. These supports can be mechanically removed or dissolved upon completion of the printing process.

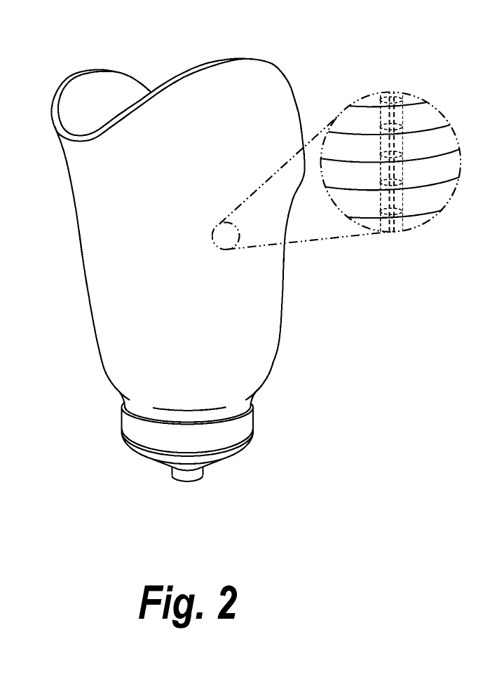

The manufacturing system 10 of the present invention is designed to form the object 14. The object 14 can have any suitable shape or size consistent with the size limitations of the additive manufacturing system 12. Although any selected object 14 can be formed, the present invention is specifically directed to the formation of prosthetic sockets for use by amputees (e.g., patients). As shown in FIGS. 2-6, and specifically in FIG. 2, the prosthetic socket 30 of the present invention includes a main body 32 that has a generally cup-like shape. The main body 32 has an outer surface 34 and an opposed inner surface 36. The inner surface forms a chamber 38 for accommodating, if desired, a liner (not shown). The residual limb of the patient seats within the chamber 38. As is known in the art, the prosthetic socket 30 can have mounted on a bottom surface 40 thereof a hinge connector 78 that forms part of a prosthetic leg. The prosthetic leg can also include a knee portion that is coupled to one end of a joint pipe, the other end of which is coupled to an ankle joint and then to a sole or foot portion. The prosthetic leg components are conventional and well known. The prosthetic socket 30 can have any selected size and shape, and is typically custom manufactured to fit a particular patient. The prosthetic socket 30 is configured to absorb the stresses typically experienced during use by the patient. The prosthetic socket 30 can have a wall thickness, as measured between the inner and outer surfaces 36, 34, between about 4.0 mm and about 15.0 mm, and preferably is about 7.0 mm thick.

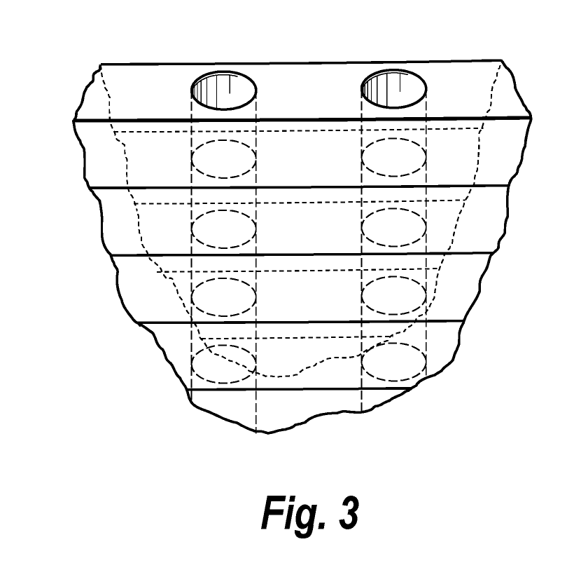

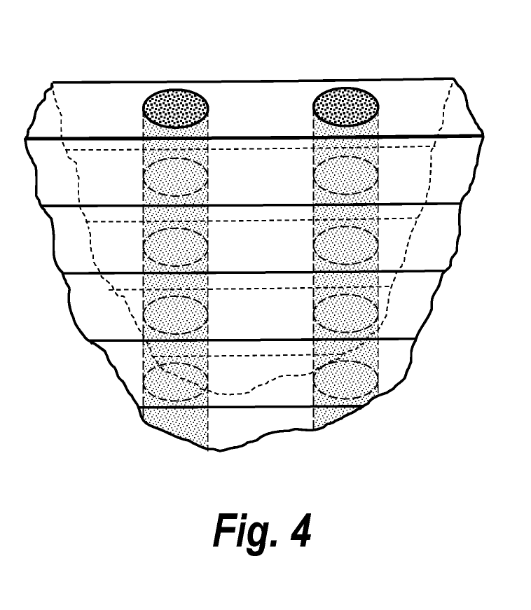

As illustrated in FIGS. 3-4, the prosthetic socket 30 of the present invention is formed by the additive manufacturing system 12 such that the channels 48 are formed in the main body of the socket 30 between the outer surface 34 and the inner surface 36. These figures simply illustrate a portion of the wall portion of the prosthetic socket, with the remainder of the main body cut away, for purposes of illustration and simplicity. The channels 48 are preferably formed in the prosthetic socket 30 during manufacture and are not formed post or after creation of the prosthetic socket 30. The channels 48 can have any selected shape, size or length, depending upon the size and shape of the prosthetic socket 30, and if circular in form can have a diameter between about 1.0 mm and about 6.0 mm, and preferably between about 4.0 mm and about 5.0 mm. Further, the prosthetic socket 30 of the present invention can have any number of channels or openings formed therein, and the channels can be uniformly spaced throughout the device or can be non-uniformly spaced throughout the device. According to one practice, the channels 48 can be concentrated if desired in certain sections or areas of the prosthetic socket 30. The channels can be formed such that they have one or more communication openings formed therein allowing access to the channel and can be formed in any surface of the prosthetic socket, including the top surface 42 and the outer surface 34. Further, the channels 48 can have any selected number of communication openings formed therein that allow communication with the channel along its length.

In operation, the manufacturing system 10 of the present invention can be used to form an object 14, such as the prosthetic socket 30. As such, the manufacturing data associated with the creation or formation of the socket can be uploaded to or generated by the manufacturing software facility 18. The manufacturing software generates a set of instructions that are sent to the dispensing device 20 for dispensing material from the material source 16 in selected amounts and in a selected pattern to start the formation of the prosthetic socket 30. According to one embodiment, the dispensing device 20 can be a printing device that forms part of a 3D printing system. The printing device thus prints the material in layers 56 according to known techniques. As the layers 56 of the prosthetic socket are being formed, each layer 56 can be formed to include a plurality of openings or voids (channels 48). The channels can be in fluid communication with the channels formed in adjacent layers, such that when the layers 56 are stacked together they form the full extent of the channels 48. The channels 48 can be formed in only a subset of the layers 56 forming the prosthetic socket 30 or can be formed in all of the layers 56 forming the prosthetic socket 30.

The channels 48 can be formed to have any specific length and shape. For example, the channels can be relatively linear and thus extend through at least a portion of the socket. Alternatively, the channels 48 have any number of bends formed therein and can also include a serpentine pattern.

Conventional prior art prosthetic sockets can be formed by molding a suitable material to form the socket. Alternatively, the sockets can be formed according to the present invention by printing techniques that build the socket body one layer at a time. The sockets formed in this manner are not formed with openings that communicate with each other to form the channels. Rather, each layer of the main body of the conventional socket is solid (e.g., voidless). A drawback of these prosthetic sockets manufactured without the channels is that stresses applied at selected force levels or for a selected time period to specific portions of the socket can result in delamination of adjacent layers. This delamination can compromise the overall structural integrity of the completed prosthetic socket. As an example, the main body 32 of the prosthetic socket 30 can separate at an interface formed between any two adjacent layers 56 if formed without the channels 48. The separation at the interface can destroy the usability of the prosthetic socket.

The prosthetic socket 30 of the present invention can be manufactured in stacked multiple layers, shown for example as layers 56 in FIGS. 3-6. The layers 56 of the main body of the prosthetic socket 30 naturally adhere to each other based on the properties of the material from which the prosthetic socket 30 is formed. The finished prosthetic socket when printed by the additive manufacturing system 12 can comprise many layers, and hence can comprise many possible points of failure. According to one practice of the invention, the channels 48 can be filled with a bonding material 62. The bonding material 62 serves to adhere or fasten the adjacent layers together so as to help minimize, avoid or prevent delamination or separation of adjacent layers 56 of the main body of the socket. The bonding material can be any suitable material sufficient to bond together adjacent layers of the prosthetic socket 30. The bonding material thus serves to strengthen the overall prosthetic socket by helping to bind together selected layers of the socket. Examples of bonding material suitable for use with the present invention include acrylic or epoxy resins and glues or any desired consistency, including liquid and paste glues. Further, the channels 48 of the present invention can be filled with the bonding material according to known techniques. Specifically, the channels can have an opening on either or both ends either through the wall (e.g., outer surface) of the device or in the top surface of the device to allow injection of the bonding material 62 and insertion of the reinforcing element 68. This injection can be done with the use of an industry standard ‘gun’ in which 2-part epoxy is mixed in a mixing tip and injected into the channel, or with the use of a more liquid glue, which can be poured or squirted into the channels allowing gravity to pull the fluid throughout the channel.

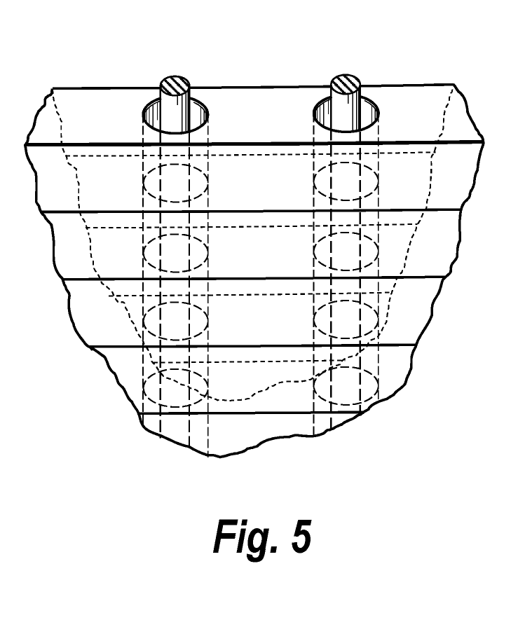

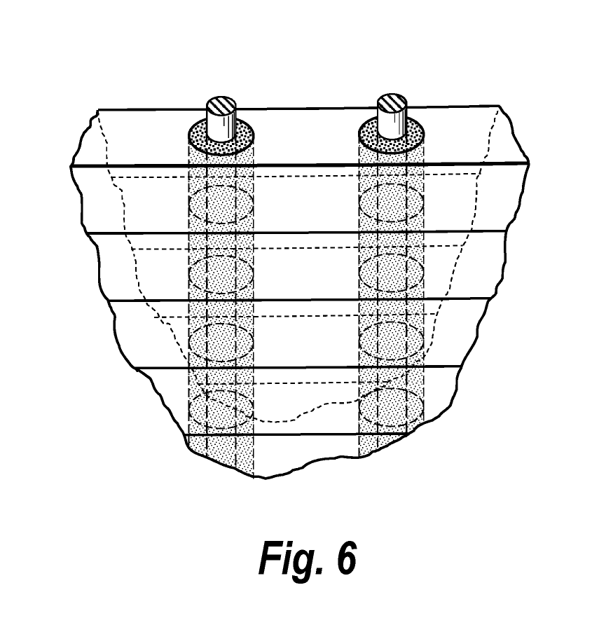

According to another embodiment of the present invention, and as shown in FIGS. 5-6, a reinforcing element 68 can be mounted in one or more, and preferably in all, of the channels 48 formed in the main body 32 of the prosthetic socket 30. The reinforcing element 68 can be formed from any selected material, such as carbon, Kevlar, nylon fiber, plastic, and metal. Any porous fiber or braid, or single porous strand of a suitable material with a strong tensile strength can be used. The reinforcing element 68 once placed in the channel is secured therein by adding the bonding material 62 to the channels. Once the bonding material hardens or cures, the reinforcing element 68 helps strengthen and add structural rigidity to the overall prosthetic socket 30.

The manufacturing software facility 18 of the additive manufacturing system 12 of the present invention can be configured to perform one or more of the above-described acts and which can be stored or encoded as computer-executable instructions executable by processing logic. The computer-executable instructions may be stored on one or more non-transitory computer readable media or stored in suitable memory. One or more of the above described acts may also be performed in a suitably-programmed electronic device, such as in a manufacturing system that incorporates one or more electronic computing devices that may be suitable for use with or to perform one or more acts disclosed herein. The electronic computing device may take many forms, including but not limited to a computer, workstation, server, network computer, quantum computer, optical computer, Internet appliance, mobile device, a pager, a tablet computer, a smart sensor, application specific processing device, controller, processor, and the like.

The illustrated manufacturing system 10 and/or associated electronic computing device may include one or more processors that include hardware and software based logic to execute any of the above functions and instructions. In one implementation, the processor may include one or more processors, such as a microprocessor. In one implementation, the processor may include hardware, such as a digital signal processor (DSP), a field programmable gate array (FPGA), a Graphics Processing Unit (GPU), an application specific integrated circuit (ASIC), a general-purpose processor (GPP), etc., on which at least a part of applications can be executed. In another implementation, the processor may include single or multiple cores for executing software stored in a memory, or other programs for controlling the computing device, and can execute instructions from the manufacturing software 18.

The additive manufacturing system 12 of the present invention may include one or more tangible non-transitory computer-readable storage media for storing one or more computer-executable instructions or software that may implement one or more embodiments of the present invention. The memory may include a computer system memory or random access memory (RAM), such as dynamic RAM (DRAM), static RAM (SRAM), extended data out RAM (EDO RAM), etc. The memory may include other types of memory as well, or combinations thereof.

One or more processors of the additive manufacturing system 12 may include a virtual machine (VM) for executing the instructions loaded in the memory. For example, a virtual machine may be provided to handle a process running on multiple processors so that the process may appear to be using only one computing resource rather than multiple computing resources. Virtualization may be employed in the computing device or additive manufacturing system so that infrastructure and resources in the computing device may be shared dynamically. Multiple VMs may be resident on a single processor.

The additive manufacturing system 12 which forms part of the manufacturing system 10 may include a network interface to interface to other networked components of the system 10, including to other computers, through a Local Area Network (LAN), Wide Area Network (WAN) or the Internet through a variety of connections including, but not limited to, standard telephone lines, LAN or WAN links (e.g., T1, T3, 56 kb, X.25), broadband connections (e.g., integrated services digital network (ISDN), Frame Relay, asynchronous transfer mode (ATM), wireless connections (e.g., 802.11), high-speed interconnects (e.g., InfiniBand, gigabit Ethernet, Myrinet) or some combination of any or all of the above. The network interface may include a built-in network adapter, network interface card, personal computer memory card international association (PCMCIA) network card, card bus network adapter, wireless network adapter, universal serial bus (USB) network adapter, modem or any other device suitable for interfacing the additive manufacturing system 12 to any type of network capable of communication and performing the operations described herein.

The additive manufacturing system may include one or more input devices, such as a keyboard, a multi-point touch interface, a pointing device (e.g., a mouse), a gyroscope, an accelerometer, a haptic device, a tactile device, a neural device, a microphone, or a camera, that may be used to receive input from, for example, a user. The computing device may include other suitable I/O peripherals. The input devices allow a user to provide input that is registered on a visual display device. A graphical user interface (GUI) may be shown on the display device. The system may also include a display of any suitable type and size.

A storage device may also be associated with or form part of the additive manufacturing system 12 or the manufacturing system 10. The storage device may be, for example, a hard-drive, CD-ROM or DVD, Zip Drive, tape drive, or other suitable tangible computer readable storage medium capable of storing information. The storage device may be useful for storing application software programs as is known in the art. The software programs may include computer-executable instructions that may implement one or more embodiments of the present invention.

The additive manufacturing system or manufacturing system can run or execute any suitable operating system (OS) and associated software applications. Examples of suitable OS may include the Microsoft® Windows® operating systems, the Unix and Linux operating systems, the MacOS® for Macintosh computers, an embedded operating system, such as the Symbian OS, a real-time operating system, an open source operating system, a proprietary operating system, operating systems for mobile computing devices, or other operating system capable of running on the computing device and performing the operations described herein. The operating system may be running in native mode or emulated mode.

One or more embodiments of the invention may be implemented using computer-executable instructions and/or data that may be embodied on one or more non-transitory tangible computer-readable mediums. The mediums may be, but are not limited to, a hard disk, a compact disc, a digital versatile disc, a flash memory card, a Programmable Read Only Memory (PROM), a Random Access Memory (RAM), a Read Only Memory (ROM), Magnetoresistive Random Access Memory (MRAM), a magnetic tape, or other computer-readable media.

One or more embodiments of the invention may be implemented in a programming language. Some examples of languages that may be used include, but are not limited to, Python, C, C++, C#, SystemC, Java, Javascript, a hardware description language (HDL), unified modeling language (UML), and Programmable Logic Controller (PLC) languages. Further, one or more embodiments of the invention may be implemented in a hardware description language or other language that may allow prescribing computation. One or more embodiments of the invention may be stored on or in one or more mediums as object code. Instructions that may implement one or more embodiments of the invention may be executed by one or more processors. Portions of the invention may be in instructions that execute on one or more hardware components other than a processor.

As noted above, the manufacturing system 10 of the present invention may also be implemented as part of a network. The manufacturing system 10 may include one or more of a computing device, a network, a service provider, and a target environment. The network may transport data from a source to a destination. The network may use known network devices, such as routers, switches, firewalls, and/or servers (not shown) and connections (e.g., links) to transport data, including manufacturing data. “Data” as used herein may refer to any type of machine-readable information having substantially any format that may be adapted for use in one or more networks and/or with one or more devices, including the additive manufacturing system 12 and associated dispensing device 20. Data may include digital information or analog information. Data may further be packetized and/or non-packetized.

The network may be a hardwired network using wired conductors and/or optical fibers and/or may be a wireless network using free-space optical, radio frequency (RF), and/or acoustic transmission paths. In one implementation, the network may be a substantially open public network, such as the Internet. In another implementation, the network may be a more restricted network, such as a corporate virtual network. The network may include Internet, intranet, Local Area Network (LAN), Wide Area Network (WAN), Metropolitan Area Network (MAN), wireless network (e.g., using IEEE 802.11, Bluetooth, etc.), etc. The network may use middleware, such as Common Object Request Broker Architecture (CORBA) or Distributed Component Object Model (DCOM). Implementations of networks and/or devices operating on networks described herein are not limited to any particular data type, protocol, architecture/configuration, etc.

The service provider may include a device that makes a service available to another device. For example, the service provider may include an entity (e.g., an individual, a corporation, an educational institution, a government agency, etc.) that provides one or more services to a destination using a server and/or other devices. Services may include instructions that are executed by a destination to perform an operation (e.g., an optimization operation). Alternatively, a service may include instructions that are executed on behalf of a destination to perform an operation on the destination's behalf.

The target environment may include a device that receives information over the network. For example, the target environment may be a device that receives user input from the computer device.

The foregoing description may provide illustration and description of various embodiments of the invention, but is not intended to be exhaustive or to limit the invention to the precise form disclosed. Modifications and variations may be possible in light of the above teachings or may be acquired from practice of the invention. For example, while a series of acts has been described above, the order of the acts may be modified in other implementations consistent with the principles of the invention. Further, non-dependent acts may be performed in parallel.

In addition, one or more implementations consistent with principles of the invention may be implemented using one or more devices and/or configurations other than those illustrated in the Figures and described in the Specification without departing from the spirit of the invention. One or more devices and/or components may be added and/or removed from the implementations of the figures depending on specific deployments and/or applications. Also, one or more disclosed implementations may not be limited to a specific combination of hardware and/or software.

Furthermore, certain portions of the invention may be implemented as logic that may perform one or more functions. This logic may include hardware, such as hardwired logic, an application-specific integrated circuit, a field programmable gate array, a microprocessor, software, or a combination of hardware and software.

No element, act, or instruction used in the description of the invention should be construed critical or essential to the invention unless explicitly described as such. Also, as used herein, the article “a” is intended to include one or more items. Where only one item is intended, the term “a single” or similar language is used. Further, the phrase “based on,” as used herein is intended to mean “based, at least in part, on” unless explicitly stated otherwise. In addition, the term “user”, as used herein, is intended to be broadly interpreted to include, for example, a computing device (e.g., a workstation) or a user of a computing device, unless otherwise stated.

It will thus be seen that the invention efficiently attains the objects set forth above, among those made apparent from the preceding description. Since certain changes may be made in the above constructions without departing from the scope of the invention, it is intended that all matter contained in the above description or shown in the accompanying drawings be interpreted as illustrative and not in a limiting sense.

It is also to be understood that the following claims are to cover all generic and specific features of the invention described herein, and all statements of the scope of the invention which, as a matter of language, might be said to fall therebetween.

Having described the invention, what is claimed as new and desired to be secured by Letters Patent is:

We claim:

1. A method of manufacturing a prosthetic socket for use by a patient, comprising
dispensing a source material to form a layer of material,
repeating the dispensing to form a plurality of stacked layers,
forming in each one of a subset of the plurality of layers, when dispensing the material, one or more channels, wherein the channels formed in each of the subset of layers communicate with each other to form a complete channel having a selected length and shape,
completing the dispensing of the source material to form the prosthetic socket, and
filling the channels with a bonding material such that the bonding material strengthens the bond between adjacent ones of the subset of the plurality of layers having the channels formed therein.

2. The method of claim 1, further comprising providing a reinforcing element in one or more of the channels prior to filling the channels with the bonding material.

3. The method of claim 1, wherein the material comprises thermoplastic, plastic, resin, metal, plaster, sandstone, nylon, polypropylene, and polyactic acid (PLA).

4. The method of claim 1, wherein the dispensing device is a printing device that forms part of a three dimensional (3D) printing system.

5. The method of claim 1, wherein the prosthetic socket has a wall thickness as measured between an inner surface of the prosthetic socket and an outer surface of the prosthetic socket between about 4.0 mm and about 15.0 mm.

6. The method of claim 1, wherein the channels formed in the layers have a diameter between about 1.0 mm and about 6.0 mm.

7. A system for manufacturing a prosthetic socket for use by a patient, comprising an additive manufacturing system including
a material source for providing a material,
a dispensing device in communication with the material source for dispensing the material,
a manufacturing software facility in communication with the dispensing device for providing manufacturing data for forming the prosthetic socket, wherein the manufacturing data includes instructions for creating the prosthetic socket by dispensing the material in a plurality of layers, wherein each one of a subset of the plurality of layers, when dispensing the material, includes one or more channels, wherein the channels formed in each of the subset of layers communicate with each other to form a complete channel having a selected length and shape,
means for filling the channels with a bonding material such that the bonding material strengthens the bond between adjacent ones of the subset of the plurality of layers having the channels formed therein.

8. The system of claim 7, further comprising a reinforcing element disposed in one or more of the channels prior to filling the channels with the bonding material.

9. The system of claim 7, wherein the material comprises thermoplastic, plastic, resin, metal, plaster, sandstone, nylon, polypropylene, and polyactic acid (PLA).

10. The system of claim 7, wherein the dispensing device is a printing device that forms part of a three dimensional (3D) printing system.

11. The system of claim 7, wherein the prosthetic socket has a wall thickness as measured between an inner surface of the prosthetic socket and an outer surface of the prosthetic socket between about 4.0 mm and about 15.0 mm.

12. The system of claim 7, wherein the channels formed in the layers have a diameter between about 1.0 mm and about 6.0 mm.
